(19) United States
(12) Patent Application Publication
(10) Pub. No.: US 2007/0170121 A1
(43) Pub. Date: Jul. 26, 2007

(54) Ultraviolet laser system for decomposing chemical pollutants

(76) Inventors: Waheed Mukaddam, Cambridge, MA (US); Allan R. Thompson, Winchester, MA (US); Charles W. Moores, Wayland, MA (US)

Correspondence Address: David Silverstein;Andover-IP-Law, 44 Park Street, Suite 300, Andover, MA, 01810, US

(21) Appl. No.: 10/588,933

(22) PCT Filed: Mar. 22, 2005
(86) PCT No.: PCT/US05/09500

§ 371 Date: Aug. 9, 2006

Related U.S. Application Data
(60) Provisional application No. 60/556,463, filed on Mar. 25, 2004.

(51) Int. Cl. C02F 1/32

(52) U.S. Cl. 210/748; 422/186.3; 204/157.61

(57) ABSTRACT

Apparatus and methods are disclosed for using an ultraviolet laser system to decompose selected chemical substances in water. More particularly, this invention provides methods and apparatus whereby various environmental pollutants in water are rapidly decomposed to very low concentrations, consistent with environmental discharge regulations, use requirements, and/or applicable health standards, by means of exposure to ultraviolet laser irradiation (10, 20), either with or without one or more catalysts and/or other chemical additives to facilitate or enhance the decomposition process.

### FIELD OF THE INVENTION

This invention relates generally to apparatus and methods wherein an ultraviolet laser system is used to decompose or otherwise alter the chemical structure of a variety of inorganic and organic chemicals, particularly chemical constituents regarded as pollutants, for example organic contaminants such as fluorinated organic compounds, such as perfluorooctanoate, and inorganic contaminants such as perchlorate, in aqueous solution and/or dispersion.

### BACKGROUND OF THE INVENTION

There are a variety of inorganic and organic, partially or fully water soluble, chemical compounds that often appear in wastewater, groundwater and drinking water, which substances are regarded as being of “environmental concern” even at very low concentrations, such as in the 1-10 parts per billion range. Examples of such substances are organic chemicals, such as polychlorinated bi-phenyls, dioxins, 1-4 dioxane, pentachlorophenol, organic perchlorates, chlorinated solvents, tri- and di-nitro toluene and fluorinated organic compounds such as perfluorooctanoate; and, inorganic chemicals such as inorganic perchlorates. Traditional water purification treatments for these chemical pollutants have included activated carbon adsorption, ultraviolet (lamp) catalyzed peroxide treatment, in-situ biological treatment, membrane filtration and containment, among others. However, the physical, chemical and/or biological properties of these chemical pollutants typically makes recovery, removal and/or decomposition to concentrations below a threshold concentration of concern prior to discharge to the environment or use of the water containing them very difficult, very expensive, and in some cases impossible.

It is generally known in the art to utilize light energy, typically in the form of an ultraviolet (UV) light source (e.g., for UV light, a mercury vapor lamp) to facilitate or catalyze certain types of chemical or biological reactions. Such processes typically deliver continuous, low-level lamp-generated radiation in the UV range over extended periods of time.

For example, representative of the prior art in this field, U.S. Pat. No. 4,012,321 teaches oxidizing refractory organic compounds in aqueous waste streams by adding hydrogen peroxide and irradiating with UV lamp light.

U.S. Pat. No. 4,661,264 teaches disinfection of water or other fluid by passing a stream of the fluid through a gas pulsed UV laser. Ultraviolet light is taught to be a known disinfection agent for water that kills bacteria by direct contact rather than by secondary photochemical effects.

U.S. Pat. No. 5,877,392 teaches decomposing nonhydrolyzable ambients, e.g., chlorofluorocarbons and nitrogen trifluoride, using UV light and a mediating species (Si) to allow chemical reactions to occur to produce an effluent which can be hydrolyzed by conventional methods. This method can be carried out in gases or liquids.

U.S. Pat. No. 5,178,772 teaches decomposing metal complexes in aqueous solution by adding an oxidizing agent and exposing the solution to UV radiation.

U.S. Pat. No. 6,692,694 teaches a method of deactivating chemical contaminants and biological agents on a surface by aerosol spraying of the surface with an electrostatically charged, photosensitizer solution, followed by illumination with UV light. This patent further teaches, however, that UV light has “limited effect on destroying chemical contamination.”

U.S. Pat. No. 4,400,270 teaches a UV sterilization and disinfection system for fluids, such as water for commercial or residential applications, to insure destruction of selected organisms.

U.S. Pat. No. 5,141,636 teaches prolonging the life of a GAC water treatment device by using UV radiation to prevent microbial proliferation on carbon surfaces by oxidizing organic contaminants in the water and thereby disinfecting the water.

Japanese patent publication JP 2001231881 teaches a method and device for decomposing pollutants, such as PCB, furan, and dioxins, to make them non-noxious by irradiation with infrared laser beams.

International patent publication WO 02/45756 teaches a process for oxidizing dangerous chemical and biological materials by spraying a region containing such materials with a gas/vapor cloud of a liquid solution containing a photocatalytic oxidizing substance, followed by directing a high intensity beam of light (wavelength 220-390 nm) across the cloud to trigger a catalyzed activation that releases free radicals that react with and thereby destroy the dangerous chemical or biological materials.

European patent publication EP 0798270 teaches a laser device for purifying contaminated water by destroying bacteriological microorganisms.

U.S. Pat. No. 5,376,281 teaches an apparatus for purifying water using UV radiation to kill and remove microbes.

British patent publication GB 2316528 teaches a process for cleaning or decontaminating the surface of an object (such as a vessel) using a UV laser beam.

Japanese patent publication JP 10075991 teaches cleaning and/or decontaminating metal or polymer surfaces to remove contaminants such as nuclear contaminants by irradiating the surface with a UV laser.

U.S. Pat. No. 6,531,065 teaches a method of treating water to remove perchlorate ion using chemical treatment in combination with UV light from a low pressure mercury lamp (mostly at about 254 nm) to convert perchlorate to a less toxic product.

U.S. Pat. No. 5,258,124 teaches a process for treating aqueous waste water or groundwater containing certain types of organic contaminants using a chemical agent in combination with UV light having a wavelength in the range of about 180-260 nm.

U.S. Pat. No. 6,773,683 teaches a photocatalytic reactor system consisting of a photonic energy source to remove undesirable contaminants (particularly sulfur oxides) from flue effluents to reduce acid rain. In one embodiment, the photonic energy source is a laser.

The foregoing prior art (which is incorporated herein by reference), however, fails to teach a quick, reliable, relatively inexpensive and substantially complete method for decomposing or otherwise chemically altering chemical substances, particularly those regarded as contaminants, in aqueous solutions and/or dispersions prior to use or discharge to the environment. Some of the known water treatment approaches, as referenced above, require treatment and/or UV lamp exposure times that can take many hours. Even with lengthy treatment times, known water treatment approaches may only eliminate about 60-80% of the concentration of chemical contaminants. Other known water treatment approaches may require adding chemicals which themselves can constitute contaminants, or else which react with the contaminant in the water to create environmentally undesirable byproducts.

These and other deficiencies in or limitations of the prior art in this field are overcome in whole or at least in part by the ultraviolet laser system and methods of this invention for treating water and decomposing chemical pollutants therein.

### OBJECTS OF THE INVENTION

A general object of the present invention is to provide apparatus and methods for cost-effectively decomposing various chemical substances, particularly pollutants, in aqueous solution and/or dispersion to concentrations that are acceptable for use of the treated water or discharge to the environment consistent with prevailing local, state, federal and/or other environmental regulations or pertinent health standards.

A more specific object of this invention is to provide an ultraviolet light laser system, and methods of using the laser system, to treat water to substantially eliminate selected organic and/or inorganic chemical constituents.

Another object of this invention is to provide a UV-laser based water treatment system and methods that decompose at least selected chemical constituents in very short times, e.g., within about 15 minutes or less, and in some instances as little as a fraction of a second, for example about 0.10-1.0 seconds, of treatment time.

Yet another object of this invention is to provide a UV-laser based water treatment system and methods that reliably decompose substantially all, e.g., greater than about 90%, of the undesirable chemical constituents in very short treatment times.

Still another object of this invention is to provide a UV-laser based water treatment system and methods to irradiate water with monochromatic laser light, all or a predominant portion of which is at wavelengths within the ultraviolet range of about 180 nm to 400 nm and, in some preferred embodiments for selected applications, about 193 nm or lower.

Yet a further object of this invention is to provide a UV-laser based water treatment system and methods capable of delivering UV laser light energy that is one or more orders of magnitude (i.e., at least ten times) greater than the light energy provided by conventional UV lamp light to a water sample to be treated.

Still a further object of this invention is to provide a pulsing technique for delivering short bursts of very high energy intensity UV laser radiation of a suitable wavelength or within a suitable wavelength range to a static or flowing water sample to be treated to rapidly decompose selected chemical substances dissolved and/or dispersed in the sample.

These and other objects, advantages and benefits of this invention will be better understood by the following description read in conjunction with FIGS. 1 and 2.

### SUMMARY OF THE INVENTION

It has been found in accordance with this invention that irradiation of water solutions and/or dispersions of certain classes of chemical substances by means of an ultraviolet laser, in some cases with or in some cases without suitable catalysts, will effectively and efficiently result in the substantially complete decomposition of these chemicals in relatively short treatment times, typically about 15 minutes or less, preferably less than about 10 minutes, more preferably less than about 5 minutes, even more preferably less than about one minute, and, in some instances, less than one second, for example about 0.10-1.0 seconds. A process in accordance with this invention utilizing an ultraviolet laser to decompose environmentally refractory chemicals in water results in a cost-effective method of realizing pollutant concentrations that are below threshold concentrations of environmental concern such that the treated water can then be safely used or discharged to the environment.

More particularly, it has been found in accordance with this invention that the very high energy intensity of laser-generated ultraviolet light pulses in combination with the monochromaticity of UV laser light has a surprising and dramatic impact on at least certain types of undesirable chemical substances that may commonly be present in an aqueous solution and/or dispersion. Such chemical substances are substantially completely decomposed (e.g., at levels of about 90% or higher decomposition) typically in a matter of only a few minutes or less of exposure of a water sample containing the chemicals to UV laser radiation, preferably at one, or several, or within a range of monochromatic UV wavelengths of about 180 nm to 400 nm, in some instances preferably about 193 nm or lower. It has been consistently found that a UV laser treatment in accordance with this invention results in higher decomposition/destruction of chemical constituents in a treated aqueous sample over a dramatically shorter period of treatment time than does light from other photonic sources, specifically light from a UV lamp.

In a preferred embodiment of this invention, the UV laser radiation wavelength(s) used is (are) selected in relation to the chemical substance(s) to be decomposed in a particular aqueous sample. It has been found that UV laser radiation wavelengths or wavelength ranges can be effectively coordinated with chemical atomic bonding energies. Thus, in accordance with an embodiment of this invention, it may be possible to identify a preferred UV laser radiation wavelength for decomposing a single chemical constituent, or to identify preferred multiple UV laser radiation wavelengths, or a preferred UV laser radiation wavelength range, for decomposing multiple chemical constituents or for addressing a single chemical constituent that may decompose into different intermediate substances prior to complete decomposition. In some instances, it has been found that UV laser radiation at about 193 nm or lower, i.e., about 180 nm-193 nm, is particularly effective in decomposing many of the chemical constituents of primary interest.

Chemicals which have been found to be effectively decomposed by the UV laser treatment of this invention include inorganic chemicals such as inorganic perchlorates, and organic chemicals such as polychlorinated bi-phenyls, dioxins, 1-4 dioxane, pentachlorophenol, tri- and di-nitro toluene, chlorinated organic solvents, and fluoriated organic compounds such as perfluorooctanoate. A particular group of chemicals that has proven to be especially responsive to treatment in accordance with this invention are the polyfluorinated straight chain organic acids having eight or more carbon atoms. The foregoing list of chemicals which may be effectively decomposed in aqueous solution and/or dispersion according to the practice of this invention is not complete. It will be a matter of routine experimentation by one of ordinary skill in this art to identify other chemically or structurally similar chemicals that respond equally well to the laser decomposition treatment of this invention. All of such chemicals are intended to be encompassed by the present invention.

The present invention thus relies on a combination of the highly monochromatic properties of laser light, on the high density of light energy that can be delivered to an aqueous sample by laser radiation, and, in some embodiments, on the selection of a UV laser light wavelength or wavelength range selected relative to the nature and strength of the chemical bonds that need to be broken to effectively decompose a chemical or chemicals in an aqueous solution or suspension. More particularly, it has been determined in accordance with preferred embodiments of this invention that a UV laser can be used to treat a water sample with a laser light energy density of at least about 0.01 millijoules (mJ) per square millimeter per pulse, and perhaps even lower, to as high as 1.0 joule per square millimeter per pulse, or even higher as improvements in laser technology may permit. Based on existing laser technology, a useful laser energy density range for the practice of this invention is about 0.10 to 10 millijoules per square millimeter per pulse, and in some specific tests performed about 0.25 to 2.0 millijoules per square millimeter per pulse. UV laser treatment of water samples within such energy/unit area ranges has been found effective in rapidly decomposing the chemical constituents of interest.

In another preferred embodiment of this invention, the UV laser light is delivered to a water sample containing a chemical to be decomposed in a series of short bursts or pulses. Such pulsed delivery of the UV laser light is limited to some extent by existing laser technology but may, in general, range from a pulse rate of about 1 pulse/second (or perhaps less in some instances) to about 50,000 pulses/second (50K hertz) or even higher as evolving laser technology permits. A preferred pulse rate range based on existing technology might be from about 10-1000 pulses per second. In some specific tests performed, a pulse rate of about 25-100 pulses/second has been used effectively. It is also within the scope of this invention to gradually ramp up and/or ramp down the pulse rate to or from the preferred pulse rate.

It should be apparent to those of ordinary skill in this art that various combinations of laser pulse rates and UV laser energy densities are capable of delivering substantially the same quantity of total UV laser energy to a water sample over any given treatment time period. Within reasonable limits, it is believed that any combinations of laser pulse rate and UV laser energy density that deliver substantially the same total UV laser energy to a water sample over a given treatment time will achieve a substantially similar degree of decomposition of chemical constituents in the treated water sample. It would therefore be a matter of routine experimentation to select or determine a suitable combination of laser pulse rate and UV laser energy density for a particular application.

In some embodiments of the present invention, the UV laser chemical decomposition process of this invention can be enhanced by adding relatively small but effective catalytic amounts of one or more non-environmentally sensitive catalysts to the water containing the chemical(s) to be decomposed. Such catalysts advantageously include, for example, iron compounds and hydrogen peroxide. It is hypothesized that some of the UV laser treatment chemical decompositions in accordance with this invention may occur primarily by a UV laser-activated hydrolysis reaction, whereas other UV laser treatment chemical decompositions operate primarily by means of a IV laser-activated reduction reaction. Because the latter reduction reaction is promoted by the presence of an electron acceptor, such decomposition treatments may especially benefit from the presence of a suitable catalyst. It may be that some chemical decompositions in accordance with this invention operate in part by both of these mechanisms, or, perhaps, by other mechanisms that have not yet been identified.

In other embodiments, the present invention may be practiced to treat water in a batch, semi-batch or continuous process. In a batch process, for example, a water sample to be treated in accordance with the present invention might be placed in an open or closed container and exposed to suitable UV laser light of appropriate wavelength for an effective period of time and at an energy level sufficient substantially to decompose the chemical(s) in the water. Mixing or agitation of the aqueous sample during treatment could optionally be used to assure that all of the water in the container is exposed to the UV laser light.

Alternatively, in a continuous treatment process, water containing a chemical or chemicals to be decomposed could be exposed to UV laser light while flowing through a conduit. In one such embodiment, at least a portion of the conduit wall could be substantially transparent to UV laser light of the appropriate wavelength. For example, the conduit might include one or more optical “windows” along its length fashioned, for example, from quartz. At each such optical window, suitable UV laser light would be directed through the window into the flowing stream of water. The flow rate of the water through the conduit, or the number of optical windows/laser stations, or both could be varied as needed to assure that the water receives exposure to the UV laser light for an effective period of time sufficient to substantially decompose the chemical(s) in the water.

In an alternative embodiment of such a continuous flow treatment process, the entire conduit, or at least a treatment portion of a conduit, could be made of quartz so as to be transparent to UV laser light along its entire length. Multiple laser beams could be used to deliver laser radiation to an aqueous stream flowing through such a conduit either at one or more discrete locations along the length of the conduit or substantially continuously along the length, or at least along a portion of the length, of the conduit.

In still another embodiment of a continuous flow treatment process in accordance with this invention, as schematically illustrated in FIG. 2, a generally linear conduit or conduit portion 20 may be provided with a fluid inlet port 22 at a first end of a conduit portion, a fluid outlet port 24 at a second end of a conduit portion, and a UV laser radiation-optically transparent window 26 (made, for example, of quartz) at at least one or the other conduit end, with the plane of the window positioned substantially perpendicular to the longitudinal axis of the conduit. In a preferred embodiment of this practice of the invention, the shape and size of the optical window is matched to the shape and size of the conduit and to the shape and size of the UV laser beam (or vice versa) in order to fully utilize all of the UV laser light and to irradiate aqueous sample even along the inner wall of the conduit.

Using this apparatus configuration, UV laser radiation can be directed through the optical window 26 so as to pass through fluid contained or flowing in the conduit with the laser radiation running substantially parallel to the longitudinal axis of the conduit 20. In this apparatus configuration, the direction of fluid flow through the conduit may be either “co-current” (in the same direction as the direction of the UV laser beam) or “counter-current” (in the opposite direction as the direction of the UV laser beam).

Any of the aforementioned and described continuous flow treatment processes of this invention may also be adapted to semi-batch processes. In such a semi-batch process, an aqueous sample to be treated would be flowed into a treatment portion of a conduit. Fluid flow would be temporarily stopped for a period of time, such as by closing valves, such as valves 23 and 25 as seen in FIG. 2, associated with the respective fluid inlet and fluid outlet ports, while the sample in the treatment conduit was treated with UV laser light in accordance with this invention. The period of time for stopping fluid flow would ordinarily be less than about 15 minutes, as described above in accordance with other invention embodiments. When the treatment had resulted in substantially complete decomposition of the subject chemical constituents, as determined for example by suitable continuous or periodic monitoring means, the treated aqueous sample would be flowed out of the treatment portion of the conduit, for example by opening valves associated with the respective fluid inlet and fluid outlet ports, and a new aqueous sample flowed into the treatment conduit.

In another embodiment of this invention, as illustrated in FIG. 1, previously-described treatment embodiments of this invention may be advantageously coupled with an aqueous sample composition continuous or semi-continuous monitoring process m conjunction with an associated monitoring system. Thus, at the same time that an aqueous sample (flowing or static) is being treated with UV laser radiation in accordance with this invention, it may be useful to continuously monitor the chemical composition of the aqueous sample, for example to determine when the decomposition of chemical constituents is substantially completed. It is known generally in the chemical arts to locate various types of sensors (e.g., temperature sensors) in a fluid undergoing chemical changes, or, alternatively, to periodically withdraw fluid samples, to monitor the rate and progress of such chemical changes, and such conventional approaches are within the scope of the present invention.

In a preferred invention embodiment, however, as schematically illustrated in FIGS. 1 and 2, at the same time that a UV laser beam 12 from a laser unit 10 is being passed through an aqueous sample in a first direction, another (second) light beam 52 (such as from a deuterium lamp) is passed through the aqueous sample being treated, at one or a plurality of locations, in a second direction that is preferably orthogonal to the first (UV laser beam) direction. Because light beams do not interfere with one another, these two steps (UV laser treatment and spectrophotometric monitoring) can be carried out simultaneously. Such a step can readily be carried out if the aqueous sample is in a treatment vessel or conduit made completely of a light-transparent material such as quartz or in a conduit having optical windows located along its wall portions. By monitoring the deuterium lamp light 54 (such as with a spectrometer 30) emerging from the aqueous sample that is being treated with the UV laser, the progress of the decomposition of chemical constituents in the aqueous sample can be continuously monitored. When the rate of change of the emerging deuterium lamp light substantially levels off, it can be concluded that chemical decomposition in the aqueous sample is substantially complete.

Other ways of practicing this invention will be apparent to those of ordinary skill in this art, and such alternative embodiments of this invention are intended to be covered by this application.

### BRIEF DESCRIPTION OF THE DRAWING

FIG. 1 is a schematic process flow diagram illustrating one embodiment for carrying out an ultraviolet laser decomposition and monitoring process in accordance with this invention.

FIG. 2 is a schematic illustration of a continuous flow treatment embodiment of the present invention in combination with a chemical composition monitoring system according to this invention.

### DETAILED DESCRIPTION OF AN EMBODIMENT OF THE INVENTION

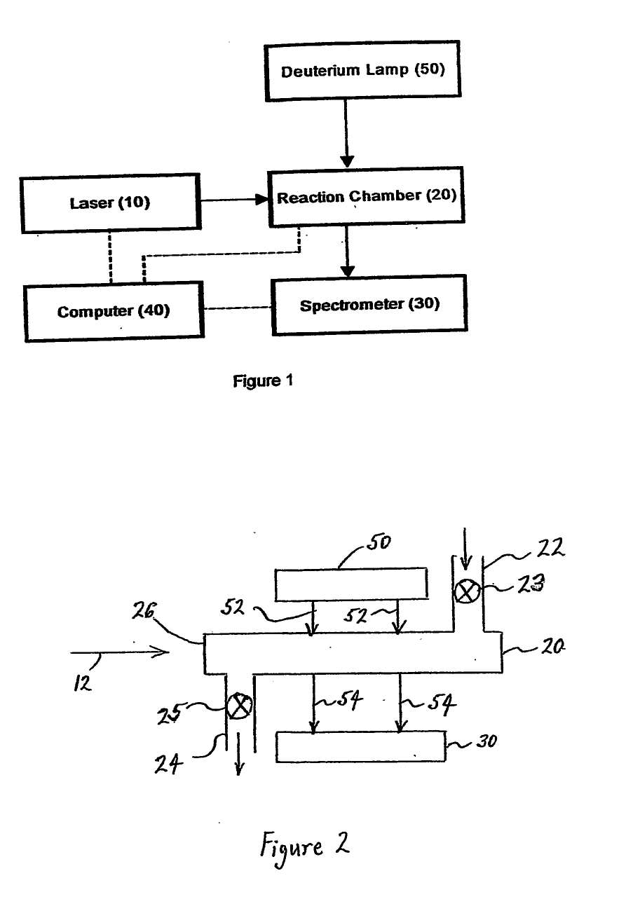

A laboratory test system for carrying out an embodiment of the present invention is illustrated in the block flow diagram of FIG. 1. As shown in FIG. 1, the principal apparatus/process elements consist of an ultraviolet (UV) laser 10, a reaction vessel, or conduit or region 20 to contain a sample of water and chemical substance(s) therein, a deuterium lamp 50, an ultraviolet spectrometer 30 and a computer system 40. A laser beam from the UV laser 10 is directed at the reaction vessel 20 through a substantially UV-transparent optical window portion (identified by reference numeral 26 in FIG. 2) of vessel 20 so as to irradiate the contents of the reaction vessel. The deuterium lamp, which is part of an ultraviolet spectrophotometer system, is preferably oriented so as to produce light beams 52 substantially at right angles to the laser beam 12 and provides a means of continuously monitoring the ultraviolet spectrophotometric signature of the contents of the reaction vessel and thus provides an indication of the chemical reactions that are occurring within the reaction vessel. Water containing a known concentration of the chemical(s) of interest is placed in the reaction vessel in accordance with this invention; and, the ultraviolet spectrophotometric signature and temperature of the contents of the reaction vessel are recorded before the laser is activated. Thereafter, the laser is activated, and the ultraviolet spectrophotometric signature and temperature of the contents of the reaction vessel are continuously measured and recorded. After a period of laser irradiation, usually less than about 15 minutes, for example an irradiation period of from about 1 second to about 10 minutes, in some embodiments from about 10 seconds to about 5 minutes, in other embodiments less than one second, the ultraviolet spectrophotometric signature of the sample has significantly changed indicating substantial decomposition of the chemical substance(s) and the concurrent detoxification of the water. The laser is turned off when the rate of change of the spectrophotometric signature slows or ceases indicating substantial completion of the chemical decomposition process. The irradiated sample is then removed from the reaction vessel for further analysis.

An irradiated sample can be analyzed, for example by means of FTIR analysis, to identify the decomposition products, and also by wet chemistry to determine the residual concentration(s) of the chemical substances remaining in the sample after the radiation step. The concentration(s) of the chemical substances in the irradiated sample is compared to the concentration(s) in a sample that has not been irradiated to judge the extent (success) of the decomposition process. Samples of varying concentrations of pollutants can be irradiated as described above, and data for these samples can be recorded and compared. Catalysts such as iron and chemicals such as hydrogen peroxide can be optionally utilized to facilitate, enhance, and/or expedite the UV laser-promoted chemical decomposition process of this invention.

### EXAMPLE

For example, in demonstrating the practice of one embodiment of this invention, a distilled water blank and various concentrations, ranging from about 5 ppm to about 500 ppm, of ammonium perfluorooctanoate (apfo) in distilled water were prepared. A portion of each apfo sample was set aside as a reference and another portion of each sample was introduced into a 22 mm diameter by 50 mm long synthetic quartz (Suprasil™) reaction vessel. The water solutions of apfo were irradiated by means of an excimer laser (LambdaPhysik LPX210i) producing a monochromatic 193 nm wavelength beam operating at an energy level of 100 millijoules per pulse at a frequency of 50 pulses per second. The laser beam was directed along (parallel to) the long axis of the reaction vessel and completely covered an 8 mm high by 22 mm wide optical window section of the reaction vessel so as to fill an 8 mm by 22 mm portion of the reactor cavity with UV laser light resulting in the delivery of a UV light energy intensity of about 0.57 millijoules/square millimeter/pulse to the sample. A 30w deuterium lamp and Zeiss MMS-UV spectrometer were mounted perpendicular to the long axis of the reaction vessel and approximately in the middle of the reaction vessel to measure the ultraviolet spectrum of the contents of the reaction vessel as a function of time while the sample was being exposed to the UV laser light. Various parameters from the experimental system were interfaced to a computer system electrically connected to the reaction vessel and the spectrometer. Samples were exposed to the UV laser beam until there ceased to be any appreciable further changes in the spectrophotometric signature of the sample (typically less than about 15 minutes). After exposure to the UV laser beam, the samples and reference solutions were sent to laboratories for FTIR and chemical analyses.

The following is a summary of the testing results:
1. The laser beam passed through the 50 mm (long axis) column of distilled water blank in the reaction vessel essentially unimpeded, and the UV spectrophotometric signature of water did not change as a result of the UV laser irradiation.
2. The laser beam was substantially absorbed in the 50 mm column of apfo-water solution at any of the concentrations tested.
3. Over a period of less than 15 minutes of irradiation, all apfo samples showed significant changes in their V spectrophotometric signatures.
4. The rate of change of the UV signatures of apfo samples varied over the period of irradiation.
5. The temperature of the apfo samples increased from room temperature to approximately 45° C. over the duration of each of the tests runs.
6. Small bubbles formed at the laser input face of the reaction vessel, presumably as a result of the UV laser irradiation treatment. The quantity of the generated bubbles appeared to be directly proportional to the initial concentrations of apfo in the respective samples.
7. FTIR analysis of the irradiated and un-irradiated samples indicated that, in all cases, there were distinct and substantial changes in the FTIR spectra after irradiation with the UV laser.
8. Quantitative analysis of the irradiated samples confirmed greater than 95% decomposition of the apfo.

The following is a summary discussion of the results presented above:
1. Distilled water in the reaction chamber was transparent to the laser beam.
2. Apfo contained in the samples tested absorbed UV light from the UV laser irradiation.
3. Due to the dramatic change in the UV spectrophotometric signatures of the samples during the irradiation treatment, it is concluded that significant chemical changes occur related to the decomposition of apfo.
4. Variations in the rate of the change of the UV spectrophotometric signatures of the irradiated samples during treatment strongly suggest the formation of some numbers of intermediate species, which are subsequently decomposed by further treatment with UV laser radiation in accordance with this invention.
5. The increase in the temperature of the apfo samples during irradiation suggests that photon energy is being transferred from the UV laser beam and converted, at least in part, into thermal energy; the increase in sample temperature during irradiation may also in part be the result of heat released from chemical reactions promoted by the UV laser irradiation.
6. Because gas bubbles did not appear during the irradiation of the distilled water sample, and the quantity of the gas bubbles appeared to be proportional to the initial apfo concentration in the samples, the gas bubbles are thought to be a gaseous reaction product from the laser decomposition of apfo in accordance with this invention.
7. FTIR analysis results showed shifts in both spectral peaks and heights that would be consistent with apfo decomposition. The FTIR signatures of the irradiated samples indicated decomposition of the larger molecules into two-carbon molecules.
8. Quantitative analysis of the irradiated samples confirmed greater than 95% decomposition of the apfo.

It will be apparent to those skilled in the art that changes and modifications may be made in the above-described apparatus and methods for an ultraviolet laser system for decomposing chemical substances in water without departing from the spirit and scope of the invention herein, and it is intended that all matter contained in the above description shall be interpreted in an illustrative and not a limiting sense.

Having described the invention, what is claimed is:

1.-30. (canceled)

31. A method for substantially completely decomposing undesirable organic chemical substance(s) in an aqueous solution and/or dispersion, said method comprising the ultraviolet laser treatment step of exposing an aqueous portion containing one or more undesirable chemical substance(s) to ultraviolet laser irradiation at a suitable ultraviolet wavelength and at a sufficient energy density for a sufficient period of time of about 15 minutes or less substantially to decompose the undesirable chemical substance(s) in the aqueous portion.

32. A method according to claim 31 wherein the ultraviolet laser irradiation used for the ultraviolet laser treatment step consists substantially exclusively of ultraviolet laser irradiation having a wavelength of about 180 nm to 400 nm (55,560 cm⁻¹ to 25,000 cm⁻¹) that delivers an energy density in the range of about 0.10 to 10 millijoules per square millimeter of ultraviolet laser beam cross-section to said aqueous portion.

33. A method according to claim 31 wherein the ultraviolet laser irradiation consists substantially exclusively of ultraviolet laser irradiation having a wavelength of about 193 nm (51,810 cm⁻¹) or lower.

34. A method according to claim 31 wherein the total period of time during which the aqueous portion is exposed to the ultraviolet laser irradiation to achieve substantially complete decomposition of at least one of the undesirable chemical substances is about 1 second to 10 minutes.

35. A method according to claim 31 wherein the total period of time during which the aqueous portion is exposed to the ultraviolet laser irradiation to achieve substantially complete decomposition of at least one of the undesirable chemical substances is less than one second.

36. A method according to claim 31 wherein 90% or more of at least one chemical substance originally present in the aqueous portion is decomposed during an ultraviolet laser irradiation period of less than 15 minutes.

37. A method according to claim 31 wherein the aqueous portion, prior to the ultraviolet laser treatment step, contains one or more chemical substances selected from the group consisting of polychlorinated bi-phenyls, dioxins, 1-4 dioxane, pentachlorophenol, tri- and di-nitro toluene, chlorinated organic compounds, fluorinated organic compounds, and mixtures thereof and, after said ultraviolet laser treatment step, the aqueous portion contains substantially none of these chemical substances.

38. A method according to claim 31 wherein the aqueous portion before the ultraviolet laser treatment step contains at least a polyfluorinated organic compound having at least eight carbon atoms and, after said ultraviolet laser treatment step, the aqueous portion contains substantially none of such chemical substance(s).

39. A method according to claim 31 wherein a catalyst is added to the aqueous portion before or during the ultraviolet laser irradiation step.

40. A method according to claim 31 wherein said ultraviolet laser irradiation is delivered to the aqueous portion in pulses at a pulse rate ranging from about 1 to 50,000 pulses per second.

41. A method according to claim 31 wherein said ultraviolet laser irradiation is delivered to the aqueous portion in pulses at a pulse rate ranging from about 10 to 1000 pulses per second.

42. A method according to claim 31 wherein said ultraviolet laser irradiation is delivered to the aqueous portion in pulses at a pulse rate ranging from about 25 to 100 pulses per second.

43. A method according to claim 31 further comprising the step of applying a combination of an ultraviolet laser pulse rate ranging from about 10 to 1000 pulses per second and an energy density ranging from about 0.10 to 10 millijoules per square millimeter of ultraviolet laser beam cross-section so as to deliver to the aqueous portion sufficient laser energy to effect substantially complete decomposition of said undesirable chemical substance(s) within a total treatment time of about 15 minutes or less.

44. A method according to claim 31 further comprising the step of applying a combination of an ultraviolet laser wavelength or wavelengths within the range of about 180 nm to about 400 nm (55,560 cm⁻¹ to 25,000 cm⁻¹), an ultraviolet laser pulse rate ranging from about 10 to 1000 pulses per second, and an energy density ranging from about 0.10 to 10 milliioules per square millimeter of ultraviolet laser beam cross-section so as to deliver to the aqueous portion sufficient laser energy at suitable wavelengths to effect substantially complete decomposition of said chemical substance(s) within a total treatment time of about 15 minutes or less.

45. A method according to claim 31 further comprising a monitoring step of periodically or continuously monitoring the concentration of the undesirable chemical substances in the aqueous portion during the ultraviolet laser treatment step.

46. A method according to claim 45 wherein said aqueous portion is treated with an ultraviolet laser light beam while flowing in a conduit having a longitudinal axis, said laser light beam being oriented substantially parallel to the longitudinal axis of said conduit, wherein said monitoring step is performed continuously during the ultraviolet laser treatment step at two or more locations along the axis of said conduit.

47. A method according to claim 45 wherein said monitoring step comprises the steps of passing a light beam: (a) through a first optically transparent wall portion of a container holding said aqueous portion during the ultraviolet laser treatment step, (b) through the aqueous portion being treated with ultraviolet laser radiation in said container, (c) out of said container through a second optically transparent wall portion of said container, and (d) into a spectrometer for monitoring the spectrophotometric signature of the aqueous portion during the ultraviolet laser treatment step.

48. A method according to claim 31 wherein the aqueous portion is exposed to the ultraviolet laser irradiation in a batch, semi-batch, or continuous flow process.

49. A method according to claim 31 wherein the treatment step of exposing the aqueous portion containing undesirable chemical substance(s) to ultraviolet laser irradiation is carried out without adding an oxidant to the aqueous portion.

50. A method according to claim 31 wherein the treatment step reduces the concentration of the chemical substance(s) in the aqueous portion to a level that is consistent with environmental regulations for discharging a treated aqueous portion to the environment.

51. A method according to claim 31 wherein the ultraviolet laser irradiation delivers at least ten times the energy of a conventional ultraviolet lamp light beam per square millimeter of ultraviolet laser beam cross-section to the aqueous portion.

52. A method according to claim 31 wherein the ultraviolet laser irradiation consists of highly monochromatic ultraviolet laser light at one or several distinct monochromatic ultraviolet wavelengths.

53. A method according to claim 52 further comprising the steps of determining the one or several monochromatic ultraviolet laser light wavelengths which are the most effective ultraviolet laser light wavelengths for decomposing the undesirable chemical substance(s) present in the aqueous portion, and delivering to the aqueous portion ultraviolet laser irradiation substantially consisting of only such most effective ultraviolet laser light wavelengths.

54. A method according to claim 31 further comprising the steps of determining the one or several ultraviolet laser light wavelengths which are the most effective ultraviolet laser light wavelengths in decomposing the undesirable chemical substance(s) present in the aqueous portion based on the respective chemical atomic bonding energies of those undesirable chemical substance(s), and delivering to the aqueous portion ultraviolet laser irradiation substantially consisting of only such most effective ultraviolet laser light wavelengths.

55. A method according to claim 31 further comprising the steps of: directing an ultraviolet laser beam from an ultraviolet laser device into a reaction vessel containing the aqueous portion through a substantially ultraviolet-transparent optical window portion so as to irradiate the contents of the reaction vessel; orienting a deuterium lamp toward the reaction vessel so as to direct light beams through the reaction vessel substantially at right angles to the ultraviolet laser beam; and, continuously monitoring the ultraviolet spectrophotometric signature of the contents of the reaction vessel using an ultraviolet spectrophotometric system to provide an indication of the chemical decomposition reactions occurring within the reaction vessel.

56. A method according to claim 55 further comprising the step of turning off the laser and removing the treated aqueous portion when the rate of change of the spectrophotometric signature significantly slows or ceases and thereby indicates substantial completion of the chemical decomposition process.

57. A method according to claim 56 wherein a water sample containing a known concentration of the undesirable chemical substances(s) of interest is placed in the reaction vessel and is treated by the ultraviolet laser treatment, the irradiated water sample is thereafter removed for further analysis, and the results of such analysis are used to ascertain the completeness of the chemical decomposition of the undesirable chemical substance(s).

58. A method according to claim 57 wherein water samples with varying known concentrations of the undesirable chemical substance(s) are irradiated with ultraviolet laser irradiation according to the method, and the results are compared for effectiveness in decomposing the substance(s).

59. A method according to claim 31 further comprising the steps of: preparing test samples consisting of a distilled water blank and different aqueous perchlorate solutions containing from 5 ppm to 500 ppm of perchlorate in distilled water; setting aside one portion of each perchlorate solution as a reference portion; treating another portion of each perchlorate solution in a synthetic quartz reaction vessel by irradiating each sample with an excimer laser producing a monochromatic 193 nm (51,810 cm⁻¹) wavelength beam operating at an energy level of 100 millijoules per pulse at a frequency of 50 pulses per second, wherein the laser beam is directed along the long axis of the reaction vessel and completely covers an optical window section of the reaction vessel so as to substantially fill the reactor cavity with ultraviolet laser light and to deliver an ultraviolet laser light energy intensity of about 0.57 millijoules/square millimeter/pulse, based on the area of the optical window section, to each treated perchlorate portion thereby obtaining 95% or greater decomposition of the perchlorate in each treated perchlorate portion over a period of less than 15 minutes of irradiation.

60. A method according to claim 59 further comprising the steps of: mounting a deuterium lamp and a spectrometer perpendicular to the long axis of the reaction vessel; directing light from the deuterium lamp through the reaction vessel and the contents of the reaction vessel and thereafter into the spectrometer; and measuring the ultraviolet spectrum of the contents of the reaction vessel as a function of time while each sample is being exposed to the ultraviolet laser light.

61. Apparatus for treating an aqueous solution and/or dispersion of undesirable inorganic chemical substance(s) so as to substantially completely decompose the undesirable chemical substance(s), said apparatus comprising in combination:
(a) a reaction vessel having an interior region to contain an aqueous portion having the undesirable chemical substance(s) during treatment;
(b) an ultraviolet laser device proximate to said reaction vessel capable of generating an ultraviolet laser beam at a wavelength or wavelength range of about 180 nm to 400 nm (55,560 cm⁻¹ to 25,000 cm⁻¹); and, (c) a laser beam window portion of said reaction vessel that is substantially transparent to ultraviolet laser radiation at wavelengths between about 180 nm to 400 nm (55,560 cm⁻¹ to 25,000 cm⁻¹) and is oriented substantially orthogonally relative to the ultraviolet laser beam to pass ultraviolet laser radiation from said ultraviolet laser device into said interior region.

62. Apparatus according to claim 61 further wherein the ultraviolet laser device is capable of producing ultraviolet laser light having at least ten times the energy of conventional ultraviolet lamp light per square millimeter of ultraviolet laser beam cross-section.

63. Apparatus according to claim 61 further comprising an analytical system for continuously monitoring changes in the chemical composition of an aqueous portion in the reaction vessel during irradiation of the aqueous portion with ultraviolet laser radiation from the ultraviolet laser device.

64. Apparatus according to claim 63 wherein said analytical system comprises an interlinked deuterium lamp device, a spectrometer, and a computer system.

65. Apparatus according to claim 64 wherein said deuterium lamp device is oriented to deliver one or more beams of light through a first optically transparent wall portion of the reaction vessel and into the interior region, through the interior region of the reaction vessel including through the aqueous portion therein, out of the interior region through a second optically transparent wall portion of the reaction vessel, and thereafter into the spectrometer.

66. Apparatus according to claim 61 wherein said reaction vessel comprises a quartz tube.

67. Apparatus according to claim 61 wherein the area and shape of said laser beam window portion of said reaction vessel are substantially the same, respectively, as the area and shape of a cross-section of the laser beam generated by the ultraviolet laser device.

68. Apparatus according to claim 61 wherein said ultraviolet laser device is capable of generating a pulsed ultraviolet laser beam capable of delivering an energy density in the range of about 0.10 millijoules to 1 joule per square millimeter per pulse to an aqueous portion in the reaction vessel at a pulse rate of about 1 to 50,000 pulses per second.

69. Apparatus according to claim 61 wherein said ultraviolet laser device generates a monochromatic laser beam at a wavelength of about 193 nm (51,810 cm⁻¹) or lower.

70. Apparatus according to claim 61 wherein said reaction vessel includes fluid inlet and fluid outlet ports such that said aqueous portion having undesirable chemical substances can be continuously flowed through the interior region of said reaction vessel.

71. Apparatus according to claim 70 further comprising valves associated respectively with said fluid inlet and fluid outlet ports for alternately stopping or resuming fluid flow.

72. Apparatus according to claim 70 wherein said fluid inlet and fluid outlet ports are arranged such that the aqueous portion is flowed through said reaction vessel in a direction of flow opposite to the direction of the ultraviolet laser beam through the vessel.
